(19) United States
(12) Patent Application Publication
(10) Pub. No.: US 2007/0242619 A1
(43) Pub. Date: Oct. 18, 2007

(54) Communication device and network selection method for use in same

(75) Inventors: Takuya Murakami, Tokyo (JP); Yoshiaki Okuyama, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/728,336

(22) Filed: Mar. 26, 2007

(30) Foreign Application Priority Data
Apr. 12, 2006 (JP) 109253/2006

(51) Int. Cl. H04J 1/16

(52) U.S. Cl. 370/252; 370/401; 370/392

(57) ABSTRACT

The present invention provides a communication device which can perform a routing process by selecting the optimum network without preparing a statically generated connection profile. A communication detection unit detects the start of communication by a communication unit, and activates a network selection unit. The network selection unit checks an application characteristic database on the basis of a parameter from the communication detection unit, and refers to a corresponding application characteristic. The network selection unit refers to a network characteristic database, and selects the optimum network. The communication unit connects the optimum network on the basis of the selection result. When the communication application starts communication, the communication detection unit notifies the communication contents learning unit of the communication contents. The communication contents learning unit analyzes the communication contents and acquires statistics, and updates the information about the application characteristic database.

### BACKGROUND OF THE INVENTION

1. Field of the Invention

The present invention relates to a communication device, and a network selection method for use in the device, and more specifically, to a method for controlling routing in connection to a plurality of networks in various communication methods in a communication device.

2. Description of the Prior Art

Recently, with an increasing use of a wireless network such as a mobile telephone network, a wireless LAN (local area network), etc., there is a greater use of connecting a mobile terminal device to various networks.

For example, a communication system includes a cellular network, a wireless LAN, a PHS (personal handyphone system) connection, Bluetooth®, etc. The networks to be connected are a cellular network, the Internet, an in-house intranet, a domestic LAN, and a VPN (virtual private network) connection to them.

When connections are simultaneously performed using an IP (Internet protocol) to a plurality of networks, there are a plurality of routes to a network service to be used by a terminal device. To perform communications, the terminal device determines a route (performs routing) to transmit a packet to an appropriate network.

Conventionally, when a routing process is performed, an available route is determined on the basis of a routing table (route table) held by a terminal device using as a key a destination IP address, that is, the IP address of a server for providing a service. However, since a route is uniquely determined only depending on a destination IP address in this method, a route cannot be flexibly selected depending on a service. For example, although there are differences in communication characteristics in Web browsing, downloading a file of a large capacity, and voice communications performed by a VoIP (voice over IP), the differences cannot be taken into account in performing the routing process.

To solve this problem, there is a method of switching a route by referring to not only a destination IP address but also a port number of a TCP/UDP (transmission control protocol/user datagram protocol) and a QoS (quality of service) parameter, which is referred to as a policy routing method. In this method, for example, a method of routing a packet to an appropriate network (communication carrier) using the source IP address of a terminal (node) (for example, the Patent Document 1 (Japanese Patent Laid-open No. H10-173703)) as a key.

However, in this method an appropriate network is selected “for each terminal device”, and a plurality of application operating in a terminal cannot select respective network. Furthermore, in this method, the optimum route cannot be dynamically changed depending on an available service and the status of an application. Therefore, for example, it would not be possible to change the present route to another route automatically whose use fee is cheaper than that of the present route, when an amount of data used by an application increases.

Since a routing process is performed using only parameters already set for an IP packet, for example, a destination IP address, a port number, a QoS parameter, etc. in the above-mentioned routing method, a route cannot be flexibly switched depending on a service using other parameters.

Furthermore, in the conventional routing control method, a method of selecting a route cannot be dynamically changed depending on the application, the status of a service or the history of the application. Therefore, it would not be possible to change a route to another route dynamically when another route becomes the optimum route at the timing.

To solve the above-mentioned problems, a conventional routing control method is disclosed, for example, in the Patent Document 2 (Japanese Patent Laid-open No. 2006-054841).

The disclosed method is provided in a communication terminal device and includes a plurality of applications which can be executed simultaneously. The applications have some connection profiles which describe the selection criteria for a network. Then, the communication terminal device is connected to an appropriate network on the basis of the connection profiles.

However, in the above-mentioned conventional method of controlling a route, for example, in the technique described in the Patent Document 2, the above-mentioned problems can be solved, but a necessary number of statically generated connection profiles are to be prepared in advance.

### BRIEF SUMMARY OF THE INVENTION

The object of the present invention is to solve the above-mentioned problems, and provide a communication device and a network selecting method therefor for performing a routing process by selecting the optimum network without providing a statically generated connection profile.

The communication device according to the present invention is a communication device which can be connected to a plurality of networks by various communications, and includes: a communication application for performing communications; a network selection unit of selecting an optimum network for communication contents of the communication application; an application characteristic database for storing the characteristic of the communication application; and a communication contents learning unit of learning the communication contents of the communication application, and updating the application characteristic database on the basis of a learning result.

The network selection method according to the present invention is a network selection method used for a communication device which can be connected to a plurality of networks by various communications, and the communication device performs: a network selection step of selecting an optimum network for communication contents of a communication application for performing communications; and a communication contents learning step of learning the communication contents of the communication application and updating an application characteristic database storing a characteristic of the communication application on the basis of a learning result.

A recording medium storing a program for a network selection according to the present invention is a recording medium storing a program of a network selection for use with a communication device connected to a plurality of networks by various communications, and is used to direct a computer to perform: a network selection step of selecting an optimum network for communication contents of a communication application for performing communications; and a communication contents learning step of learning communication contents of the communication application, and updating an application characteristic database storing a characteristic of the communication application on the basis of a learning result.

That is, the communication device according to the present invention can automatically and constantly select the optimum network by dynamically changing the method of determining a route depending on the available application, the status of a service or the history of the application.

In more details, the communication device according to the present invention includes a communication application, a communication unit, communication detection unit, communication contents learning unit, network selection unit, an application characteristic database, and a network characteristic database.

The communication application receives a service by connection to a network using a communication unit. When the communication detection unit detects the start of communications by the application, the network selection unit checks the application characteristic database and the network characteristic database, automatically determines a network that satisfies the communication condition of the communication application and is the most advantageous in the conditions of communication efficiency and a communication fee, and notifies the communication unit of the determination. Thus, the optimum network and connection route for the communication application can be selected.

The communication contents detected by the communication detection unit are transmitted to the communication contents learning unit, and learning is performed. At this time, the contents of the learning can be the type of application, a connection destination address, a port number, an amount of communication data, a communication frequency, a used network, a communication fee, time, etc. A learning result is stored in an application characteristic database. Thus, the application characteristic database can be constantly kept in the latest status.

With the above-mentioned configuration and operation, the present invention has the effect that the optimum network can be selected for routing without preparing a statically generated connection profile.

### BRIEF DESCRIPTION OF THE DRAWINGS

FIG. 1 is a block diagram showing the configuration of the communication terminal device according to a first embodiment of the present invention;

FIG. 2 shows an example of the configuration of the application characteristic database shown in FIG. 1;

FIG. 3 shows an example of the configuration of the network characteristic database shown in FIG. 1;

FIG. 4 is a flowchart showing the operation of the communication terminal device shown in FIG. 1;

FIG. 5 is a flowchart showing the operation of the communication terminal device shown in FIG. 1;

FIG. 6 is a block diagram showing the configuration of the communication terminal device according to a second embodiment of the present invention;

FIG. 7 is a flowchart showing the operation of the communication terminal device according to the second embodiment of the present invention;

FIG. 8 is a flowchart showing the operation of the communication terminal device according to the second embodiment of the present invention;

FIG. 9 is a block diagram showing the configuration of the communication terminal device according to a third embodiment of the present invention;

FIG. 10 shows the configuration of the application characteristic database shown in FIG. 9;

FIG. 11 is a flowchart showing the operation of the communication terminal device according to the third embodiment of the present invention;

FIG. 12 is a flowchart showing the operation of the communication terminal device according to the third embodiment of the present invention;

FIG. 13 is a block diagram showing the configuration of the communication terminal device according to a fourth embodiment of the present invention;

FIG. 14 is a flowchart showing the operation of the communication terminal device according to the fourth embodiment of the present invention; and

FIG. 15 is a flowchart showing the operation of the communication terminal device according to the fourth embodiment of the present invention.

### DETAILED DESCRIPTION OF THE PREFERRED EMBODIMENTS

The embodiments of the present invention are described below by referring to the attached drawings.

### Embodiment 1

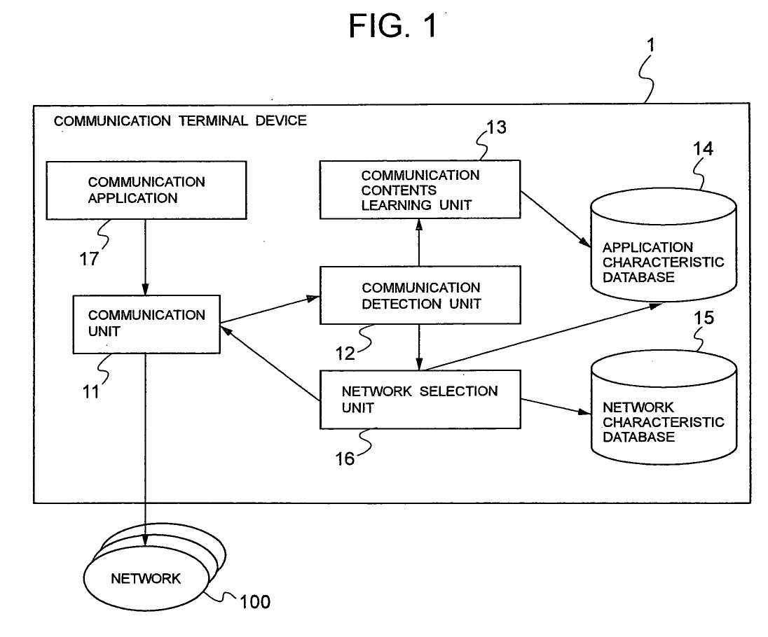

FIG. 1 is a block diagram showing the configuration of the communication terminal device according to a first embodiment of the present invention. In FIG. 1, a communication terminal device 1 is a communication device capable of receiving a network service by connection to one or more networks 100 simultaneously or by switching, and includes a communication unit 11, a communication detection unit 12, a communication contents learning unit 13, an application characteristic database 14, a network characteristic database 15, a network selection unit 16, and a communication application 17.

The type of network 100 can be various networks such as the Internet, the Intranet, a wireless LAN (local area network) spot, a domestic LAN, an in-shop LAN, etc.

The communication terminal device 1 is connected to the network 100 using the communication unit 11. At this time, a connecting medium can be, for example, a cable LAN, a wireless LAN, a public telephone network, a mobile telephone network, a PHS (personal handy-phone system), an IrDA (infrared data association), Bluetooth®, a serial communication, etc. A protocol for use in communication is a TCP/IP (transmission control protocol/Internet protocol).

A virtual network connection can be performed using a VPN (virtual private network), which can be referred to as a type of network 100.

When the communication terminal device 1 receives a network service, it uses the communication application 17. The communication application 17 is connected to the network 100 using the communication unit 11 and receives a service. An example of the communication application 17 can be a Web browser, a mail client, a file transfer program, VoIP (voice over IP) communication application, animation and voice streaming regeneration applications, online games, etc.

The application characteristic database 14 stores the characteristic of the communication application 17. It stores the identifier (application program name, etc.) of an application, a port number of a communication destination host name/IP address, a connection destination TCP/UDP (transmission control protocol/user datagram protocol), a communication frequency, an amount of communication data, a used network, a communication fee, time, etc.

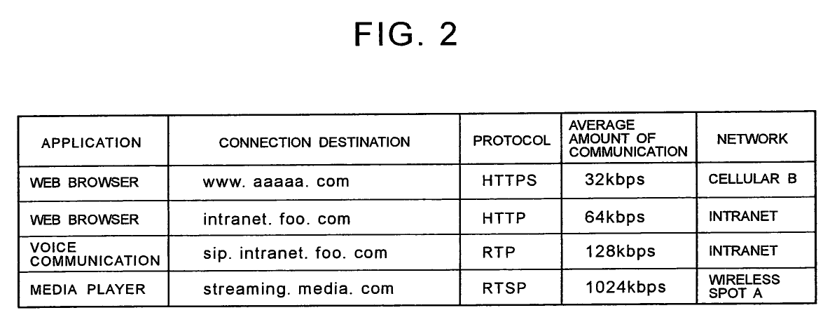

FIG. 2 shows an example of the configuration of the application characteristic database 14 shown in FIG. 1. The application characteristic database 14 stores: an application (“Web browser”, “voice communication”, “media player”); a connection destination (“www.aaaaa.com”, “intranet.foo.com”, “sip.intranet.foo.com”, “streaming.media.com”); a protocol (“HTTPS[HTTP (HyperText transfer protocol) over SSL (secure sockets layer)]”, “HTTP”, “RTP (real time transport protocol)”, “RTSP (real time streaming protocol)”); an average amount of communication (“32 kbps”, “64 kbps”, “128 kbps”, “1024 kbps”); and network (“cellular B”, “Intranet”, “wireless spot A”).

Thus, in the present embodiment, as shown in FIG. 2, an application, a communication destination host, a communication protocol, an average amount of communication, and a used network are learned and stored in the application characteristic database 14.

The application characteristic database 14 is realized by a method of setting data in advance and a method of automatically learning data. In a method of setting data in advance, data is manually set, an application automatically sets data when the application is installed, or data is automatically set using another setting application.

When data is automatically learned, the communication contents learning unit 13 automatically sets or updates the data. The communication contents learning unit 13 learns the communication contents when the communication application 17 performs communications, and stores a learning result in the application characteristic database 14.

When the communication application 17 is activated and starts communications, the communication detection unit 12 detects the start of the communications and notifies the network selection unit 16 of the start. The network selection unit 16 refers to the application characteristic database 14 and the network characteristic database 15, and determines the optimum network.

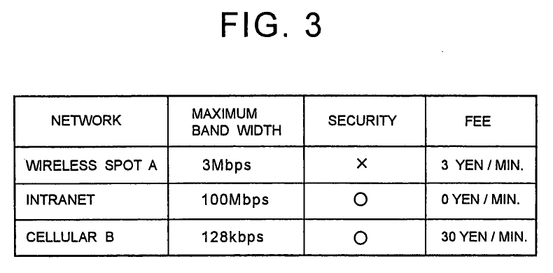

FIG. 3 shows an example of the configuration of the network characteristic database 15 shown in FIG. 1. In FIG. 3, the network characteristic database 15 stores: a network (“wireless spot A”, “Intranet”, “cellular B”); a maximum band width (“3 Mbps”, “100 Mbps”, “128 kbps”); security (“X”, “◯”); and a fee (“3 yen/min.”, “0 yen/min.”, “30 yen/min.”).

The network selection unit 16 selects the optimum network using the information stored in the databases. There can be various methods as determination criteria. In the present embodiment, it is assumed that a network having a band width and security sufficient for satisfying the request for the communication of an application, and requiring the lowest possible fee is selected.

When the network selection unit 16 determines the optimum network, it notifies the communication unit 11 of the network. The communication unit 11 determines a communication route according to the information from the network selection unit 16, and transmits the communication data from the communication application 17 on the basis of the determination.

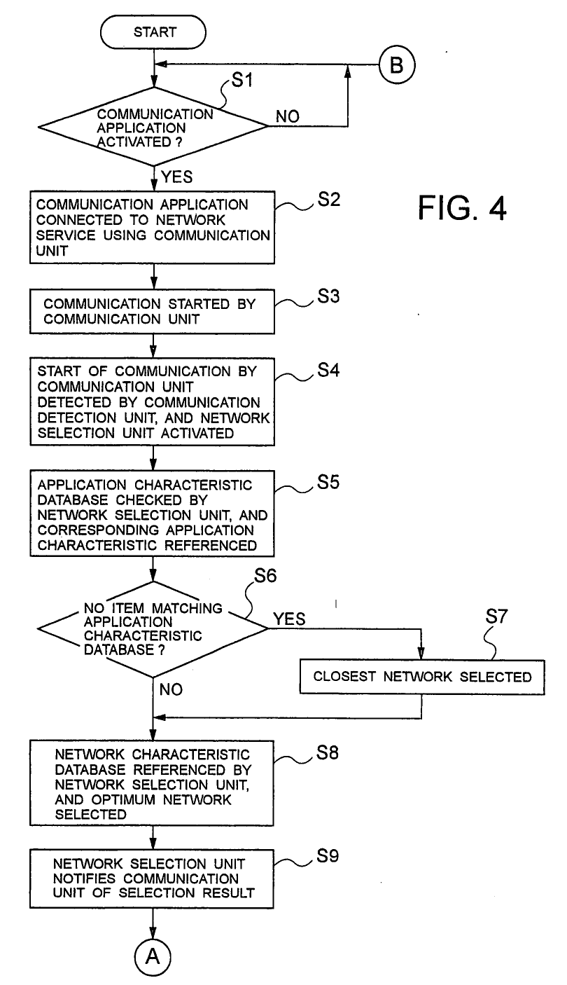

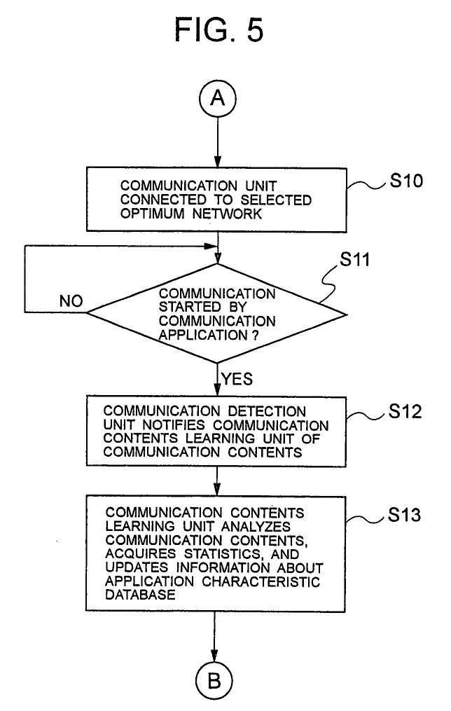

FIGS. 4 and 5 show the flowcharts of the operation of the communication terminal device 1 shown in FIG. 1. By referring to FIGS. 1 to 5, the operation of the communication terminal device 1 according to the first embodiment of the present invention is described below. The processes shown in FIGS. 4 and 5 can also be realized by the CPU (central processing unit not shown in the attached drawings) of the communication terminal device 1 executing a program.

When a user uses a service, the user first activates the communication application 17. The communication application 17 is connecting a network service using the communication unit 11 (steps S1 and S2 shown in FIG. 4).

When the communication unit 11 is starting communications (step S3 shown in FIG. 4), the communication detection unit 12 detects it and activates the network selection unit 16 (step S4 shown in FIG. 4). At this time, the communication detection unit 12 passes as parameters the identifier (name) of the communication application 17, and the details of the protocol through which a communication is to be started (for example, the host name and the port number, etc. of a communication destination) to the network selection unit 16.

The network selection unit 16 checks the application characteristic database 14 on the basis of the parameter from the communication detection unit 12, and refers to the corresponding application characteristics (step S5 shown in FIG. 4). If the communication application 17 activates a medium player to start communications through the RTSP communication protocol to “streaming.media.com”, it is informed that the communications are performed on average “1024 kbps” from the characteristic of the application shown in FIG. 2.

The network selection unit 16 selects the closest network (step S7 shown in FIG. 4) when there is no item matching in the application characteristic database 14 (step S6 shown in FIG. 4). For example, when the “Web browser” is being connected to “www.example.com” through the “HTTPS”, an entry matching in application and protocol is retrieved, and “32 kbps” as the amount of communication, and the “cellular B” as a connection network are assumed.

The network selection unit 16 refers to the network characteristic database 15, and selects the optimum network (step S8 shown in FIG. 4). As an example, in FIG. 2, the “wireless spot A” and the “Intranet” satisfy the requirements of the band width, but the “cellular B” does not. Since it is clear that the “Intranet” is advantageous in security and fee, the first candidate is the “Intranet”, and the second candidate is the “wireless spot A”.

When the protocol as a partner in communications is not good in security, the “Intranet” whose network security is guaranteed is selected, and the “wireless spot A” is not selected. A protocol not good in security refers to a protocol through which a password and confidential information are not encrypted and transmitted over a network such as a POP (post office protocol), an SMTP (simple mail transfer protocol), a telnet, etc.

The network selection unit 16 notifies the communication unit 11 of the selection result (step S9 shown in FIG. 4), and the communication unit 11 makes a connection to the optimum network on the basis of the selection result (step S10 shown in FIG. 5).

When the communication application 17 starts communications (step S11 shown in FIG. 5), the communication detection unit 12 notifies the communication contents learning unit 13 of the communication contents (step S12 shown in FIG. 5). The communication contents learning unit 13 analyzes the communication contents received from the communication detection unit 12 and acquires statistics, and updates the information about the application characteristic database 14 (step S13 shown in FIG. 5). For example, if the communication application 17 performs the communications of “2048 kbps” from the “download.media.com”, the communication contents learning unit 13 records the history in the application characteristic database 14.

In the above-mentioned operation, the communication terminal device 1 can be automatically connected to the optimum network on the basis of the history of the communication application 17. The communication application 17 can simultaneously perform a plurality of communication sessions. The above-mentioned operation is assumed to be individually performed for each communication session. For example, when the “Web browser” simultaneously performs respective communications on a plurality of servers (not shown in the attached drawings), the determination process and the learning process of a network are performed on each session.

Thus, in the present embodiment, the optimum network/route can be automatically selected for each service used by the communication application 17 so that the optimum network can be automatically determined by the network selection unit 16 checking a database such as the application characteristic database 14, the network characteristic database 15, etc. before starting the communications of the communication application 17.

In the present embodiment, since the communication contents learning unit 13 learns the communication history of the communication application 17, the application characteristic database 14 can be constantly kept in the optimum state. Since the above-mentioned process is automatically performed, it is not necessary for the communication application 17 to perform a process of selecting a network. Therefore, any application can automatically optimize a route, thereby reducing the cost required to develop an application.

Thus, in the present embodiment, the application characteristic database 14 and the network characteristic database 15 are checked to automatically select a network matching the characteristic of an application. Therefore, the optimum network can be selected and an appropriate routing process can be performed for each service available by an application without preparing a statically generated connection profile. As a result, according to the present embodiment, a different route can be determined for each service, which cannot be realized by any conventional technique.

Furthermore, according to the present embodiment, since the optimum network can be selected for each service used by an application, the communication cost can be reduced while guaranteeing a necessary communication band, security, and QoS (quality of service).

In addition, according to the present embodiment, since an application database can be constantly updated by learning the communication history of an application each time the application is used, a selected network can be dynamically optimized.

Furthermore, according to the present embodiment, since the above-mentioned operation can be automatically performed regardless of an application, the above-mentioned effect can be obtained without adding any process to the communication application 17. Thus, in the present embodiment, the development cost for an application can be reduced.

### Embodiment 2

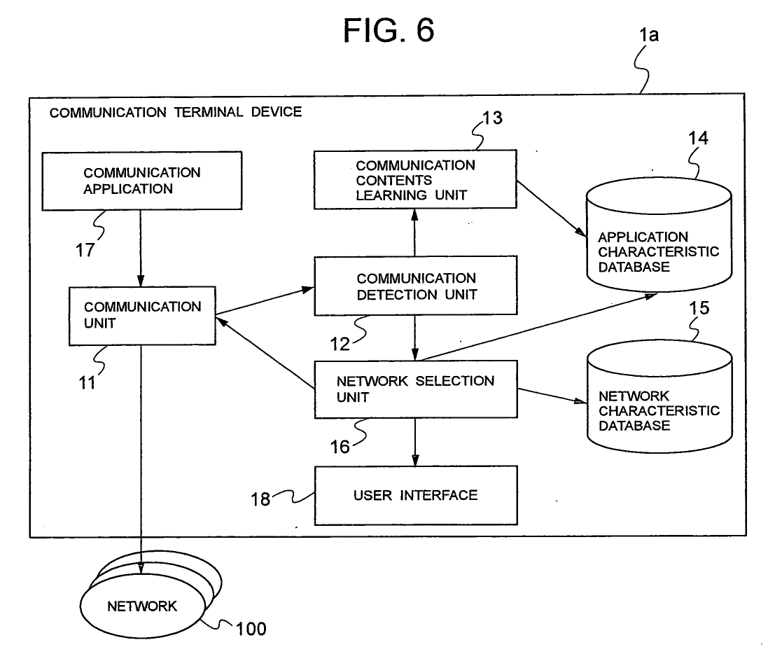

FIG. 6 is a block diagram showing the configuration of the communication terminal device according to the second embodiment of the present invention. In FIG. 6, the communication terminal device 1a according to a second embodiment of the present invention has the same configuration as the communication terminal device 1 according to the first embodiment of the present invention shown in FIG. 1 except that a user interface 18 is newly added, and the same component is assigned with the same reference numeral. The operation of the same component in the present embodiment is identical to the operation according to the first embodiment of the present invention.

The user interface 18 presents and selects a network that can be selected by a user in selecting a network, and enables a user to use it when the user amends the characteristic of an application. The user interface 18 has a display unit or the function of outputting voice as a display unit for presenting information to a user, and also has a keyboard, a switch, or a voice input device for receiving information from a user.

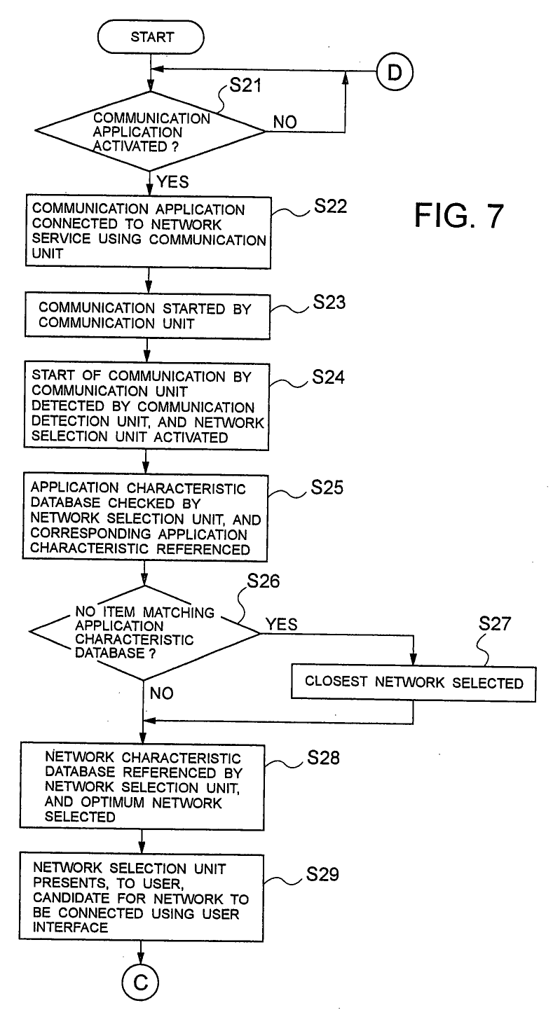

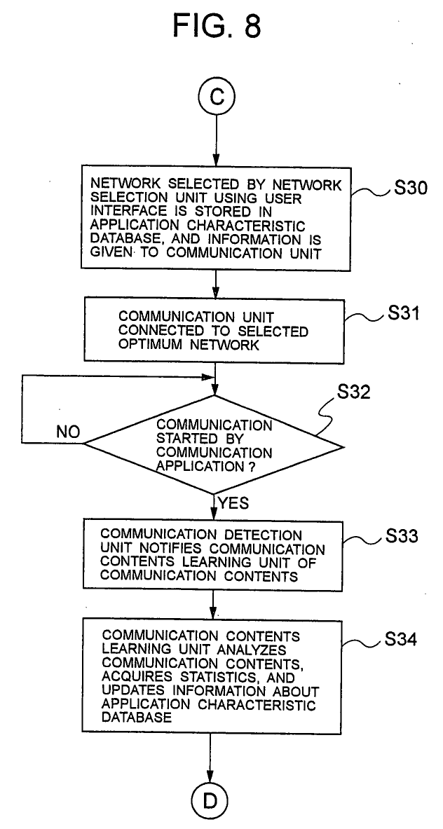

FIGS. 7 and 8 are flowcharts of the operation of the communication terminal device 1a according to the second embodiment of the present invention. The operation of the communication terminal device 1a according to the second embodiment of the present invention is described below by referring to FIGS. 6 to 8. The processes shown in FIGS. 7 and 8 can also be realized by executing a program by the CPU (not shown in the attached drawings) of the communication terminal device 1a. In the processes shown in FIGS. 7 and 8, since the processes in steps S21 to S28, S31 to S34 are the same as the processes in steps S1 to S8, and S10 to S13 shown in FIGS. 4 and 5, the description is omitted here.

When the communication application 17 is connecting a network, the network selection unit 16 is activated and performs a network determining process. At this time, the network selection unit 16 presents to a user a candidate for a network to be connected using the user interface 18 (step S29 shown in FIG. 7).

The user confirms the candidate for a network and issues an instruction as to which network is to be used through the user interface 18. Then, the network selection unit 16 stores a network selected using the user interface 18 in the application characteristic database 14, notifies the communication unit 11 of the selected network (step S30 shown in FIG. 8), and starts communications using the optimum network.

Thus, according to the present embodiment, when the network selected by the network selection unit 16 does not satisfy a user request, it can be corrected. Although the network selection unit 16 tries to automatically select a network from the communication history of the communication application 17, it is not possible to determine what type of communications the user wishes to perform actually. Therefore, it is not guaranteed that a 100% perfect and optimum network can be selected, and there is the possibility that a non-optimum network is mistakenly selected.

According to the present embodiment, a user has the opportunity to correct such an error. Also according to the present embodiment, the communication history stored in the application characteristic database 14 can be amended using the user interface 18.

### Embodiment 3

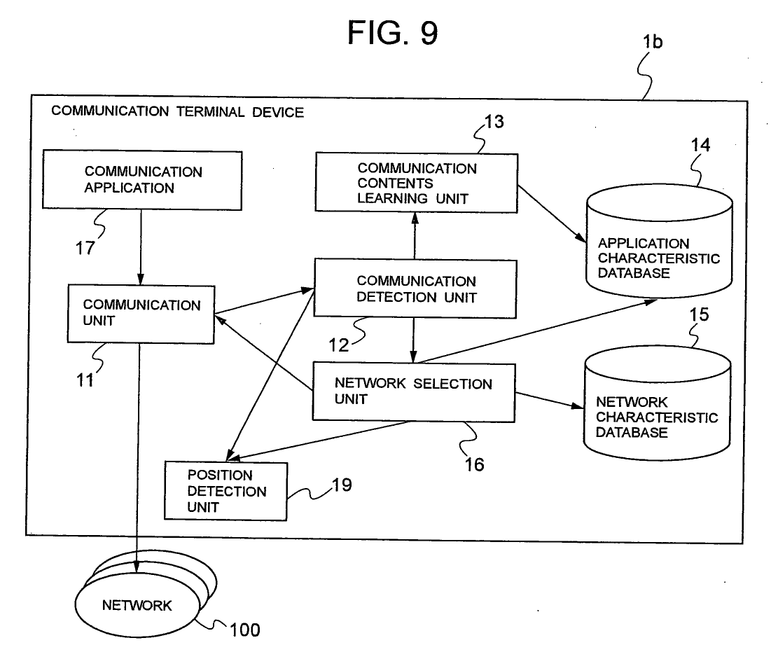

FIG. 9 is a block diagram showing the configuration of the communication terminal device according to the third embodiment of the present invention. In FIG. 9, the communication terminal device 1b according to a third embodiment of the present invention has the same configuration as the communication terminal device 1 according to the first embodiment of the present invention shown in FIG. 1 except that a position detection unit 19 is newly added, and the same component is assigned with the same reference numeral. The operation of the same component in the present embodiment is identical to the operation according to the first embodiment of the present invention.

The position detection unit 19 is a unit of obtaining the current position information of the communication terminal device 1b. Practically, there is a method of designating the current position of the device using the position information through a GPS (global positioning system) or a basic station (not shown in the attached drawings) of a mobile telephone network, or the SSID (service set identifier) or a MAC (media access control) address of an access point (not shown in the attached drawings) of a wireless LAN.

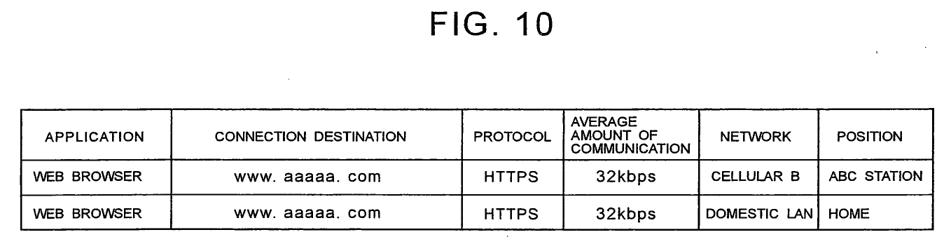

FIG. 10 shows the configuration of the application characteristic database 14 shown in FIG. 9. In FIG. 10, the application characteristic database 14 stores an application (“Web browser”), a connection destination (“www.aaaaa.com”), a protocol (“HTTPS”), an average amount of communication (“32 kbps”), a network (“cellular B”, “domestic LAN”), a position (“ABC Station”, “home”).

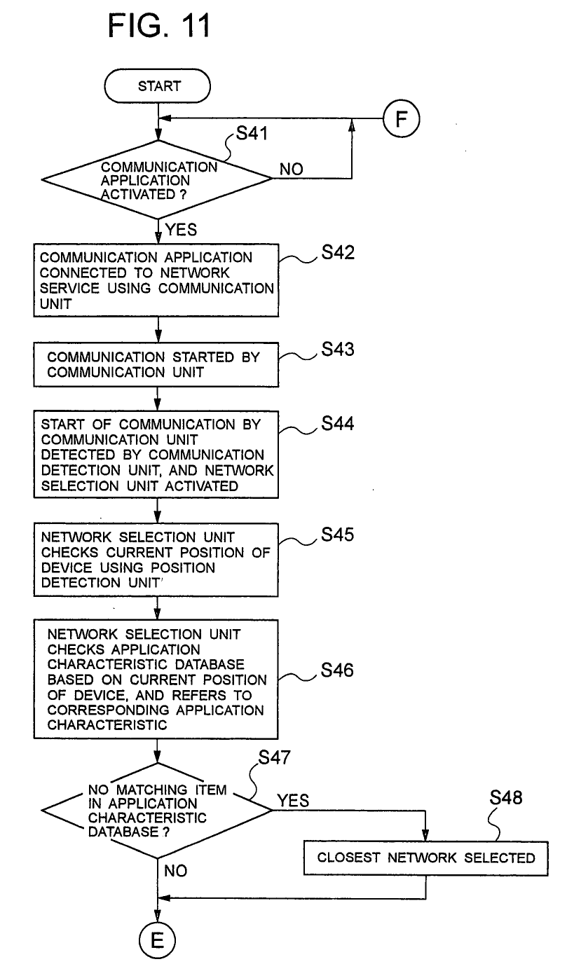

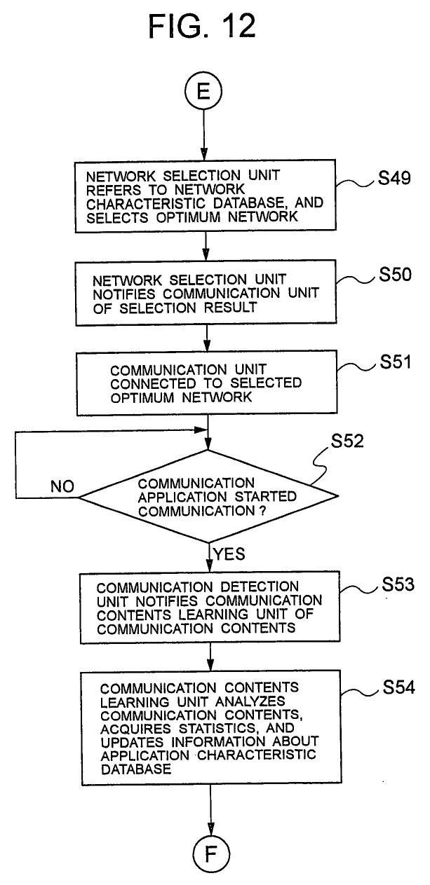

FIGS. 11 and 12 are flowcharts of the operation of the communication terminal device 1b according to the third embodiment of the present invention. The operation of the communication terminal device 1b according to the third embodiment of the present invention is described below by referring to FIGS. 9 to 11. The processes shown in FIGS. 11 and 12 can also be realized by executing a program by the CPU (not shown in the attached drawings) of the communication terminal device 1b. In the processes shown in FIGS. 11 and 12, since the processes in steps S41 to S44, and S47 to S54 are the same as the processes in steps S1 to S4, and S6 to S13 shown in FIGS. 4 and 5, the description is omitted here.

When the communication application 17 is connecting a network, the network selection unit 16 is activated and performs a network determining process. The network selection unit 16 checks the current position of the device using the position detection unit 19 (step S45 shown in FIG. 11), and the current position is used in checking the application characteristic database 14 (step S46 shown in FIG. 11). The application characteristic database 14 stores the position information used when an application is used, and the network selection unit 16 checks on a priority basis the data matching the current position as shown in FIG. 10.

When the communication contents learning unit 13 learns the communication contents, the position of the communication terminal device 1b during communication is stored in the application characteristic database 14.

Thus, according to the present embodiment, in addition to the effect of the first embodiment, a network can be selected depending on the position of the communication terminal device 1b. For example, different learning and network selection policies can be assigned between a home use and an office use, and when a specific service is received, the wireless LAN is prioritized at home while the mobile telephone network is prioritized in office. Thus, according to the present embodiment, a network can be selected more effectively.

### Embodiment 4

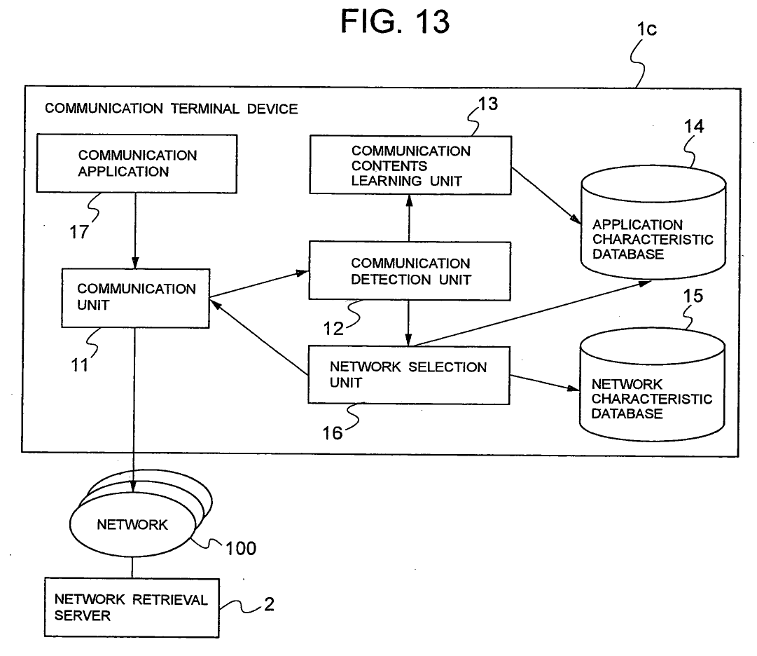

FIG. 13 is a block diagram showing the configuration of the communication terminal device according to a fourth embodiment of the present invention. In FIG. 13, the communication terminal device 1c according to the fourth embodiment of the present invention has the same configuration as the communication terminal device 1 according to the first embodiment of the present invention shown in FIG. 1 except that it can be connected to a network retrieval server 2 through the network 100, and the same component is assigned with the same reference numeral. The operation of the same component in the present embodiment is identical to the operation according to the first embodiment of the present invention.

The network retrieval server 2 is a server for retrieving the optimum network depending on the desired application and communication contents. The network retrieval server 2 stores a database similar to the application characteristic database 14, and can retrieve the network 100 indicating the matching condition according to the information transmitted from the communication terminal device 1c. Furthermore, the network retrieval server 2 receives the learned communication contents from the communication terminal device 1c, and updates its own database.

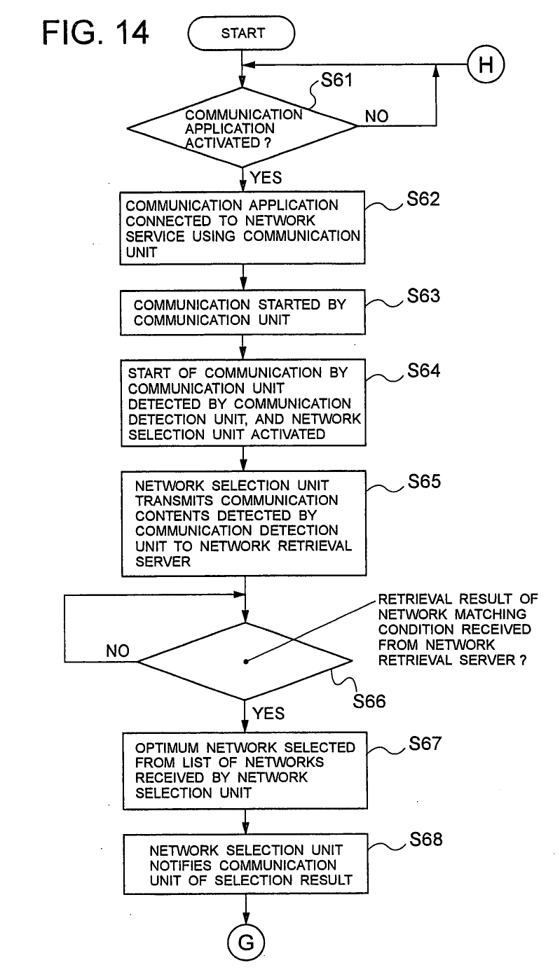

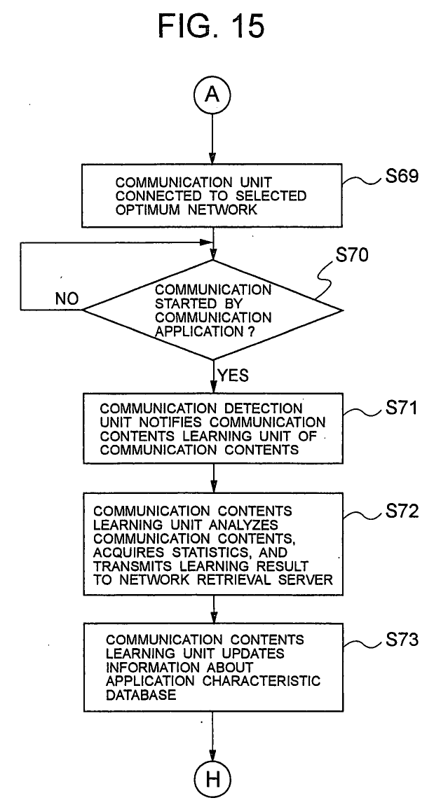

FIGS. 14 and 15 are flowcharts of the operation of the communication terminal device 1c according to the fourth embodiment of the present invention. The operation of the communication terminal device 1c according to the fourth embodiment of the present invention is described below by referring to FIGS. 13 to 15. The processes shown in FIGS. 14 and 15 can also be realized by executing a program by the CPU (not shown in the attached drawings) of the communication terminal device 1c. In the processes shown in FIGS. 14 and 15, since the processes in steps S61 to S64, S68 to S71 are the same as the processes in steps S1 to S4, and S9 to S12 shown in FIGS. 4 and 5, the description is omitted here.

When the communication application 17 is connecting a network, the network selection unit 16 is activated and performs a network determining process. The network selection unit 16 transmits the communication contents detected by the communication detection unit 12 to a network retrieval server 2 (step S65 shown in FIG. 14). The network retrieval server 2 retrieves a network matching in condition on the basis of the received data, and transmits the retrieval result to the communication terminal device 1c. The network selection unit 16 selects the optimum network from the list of networks received (step S66 and S67 shown in FIG. 14).

It is not necessary for the network selection unit 16 to use the application characteristic database 14 and the network characteristic database 15, but can narrow down the optimum network by a combination use of the result returned by the network retrieval server 2.

After the communication contents learning unit 13 learns communication contents, it transmits the learning result to the network retrieval server 2 (step S72 shown in FIG. 15), and updates the application characteristic database 14 on the basis of the learning result (step S73 shown in FIG. 15). The network retrieval server 2 updates its own database on the basis of the result received from the communication terminal device 1c.

Thus, according to the present embodiment, since the network retrieval server 2 as an external device can have a database for selecting the network 100 and a retrieving function, the size of the database to be stored in the communication terminal device 1c can be reduced, and the calculating process relating to the retrieval of the database can be decreased.

Furthermore, according to the present embodiment, an application and a service not learned by the communication terminal device 1c can be available so far as the network retrieval server 2 stores the information. In addition, an external device can use the information by the communication terminal device 1c transmitting learned data to the network retrieval server 2 and managing the data therein.

Furthermore, according to the present invention, by setting the function of retrieving a network outside the communication terminal device 1c, the retrieving function can be provided by the third party other than a user of the device. For example, a retrieving service to inform of a network of the lowest possible fee with a high speed process can be provided for various services such as a Web service, a voice communication service, etc. Such a retrieval service provider can also collect an advertisement fee from a network runner, thereby providing a new business model.

The present invention can be applied to a terminal device connected to a network, and a communication application program for operation on the device. Furthermore, it also can be applied to a server device for providing the optimum network.

What is claimed is:

1. A communication device which can be connected to a plurality of networks by various communications, comprising:
a communication application for performing communications;
network selection means of selecting an optimum network for communication contents of the communication application;
an application characteristic database for storing a characteristic of the communication application; and
communication contents learning means of learning the communication contents of the communication application, and updating the application characteristic database on the basis of a learning result.

2. The communication device according to claim 1, further comprising:
communication detection means of detecting the communication contents; and
a network characteristic database for storing a characteristic of each of the plurality of networks, wherein
the network selection means selects the appropriate network by referring to the network characteristic database on the basis of the communication contents detected by the communication detection means.

3. The communication device according to claim 2, wherein
the network selection means searches a network satisfying a condition required by the communication application from the network characteristic database.

4. The communication device according to claim 2, wherein
the network selection means searches a network satisfying a condition most advantageous for a communication fee for the communication application from the network characteristic database.

5. The communication device according to claim 1, further comprising:
communication detection means of detecting the communication contents of the communication application; and
a network characteristic database for storing each characteristic of the plurality of networks, wherein
the network selection means selects an appropriate network by checking the application characteristic database and the network characteristic database.

6. The communication device according to claim 1, wherein
the communication contents learning means learns a connection destination address of the communication application.

7. The communication device according to claim 1, wherein
the communication contents learning means learns a connection destination TCP (transmission control protocol) port number or a UDP (user datagram protocol) port number of the communication application.

8. The communication device according to claim 1, wherein
the communication contents learning means learns an amount of communication or a frequency of the communication application.

9. The communication device according to claim 1, wherein
the communication contents learning means learns a position of the communication device itself when the communication application is being used.

10. the communication device according to claim 1, wherein
a user interface for correction of learning contents of the communication contents learning means is included.

11. The communication device according to claim 1, wherein
the network selection means selects an appropriate network on the basis of a search result from a network retrieval server device for searching an optimum network depending on an identifier or communication contents of the communication application.

12. A network selection method used for a communication device which can be connected to a plurality of networks by various communications, wherein the communication device comprising:
a network selection step of selecting an optimum network for communication contents of a communication application for performing communications, and a communication contents learning step of learning the communication contents of the communication application and updating an application characteristic database storing a characteristic of the communication application on the basis of a learning result.

13. The network selection method according to claim 12, wherein
the communication device performs a communication detection step of detecting the communication contents, and selecting, in the network selection step, an appropriate network by referring to a network characteristic database storing each characteristic of the plurality of network on the basis of communication contents detected in the communication detection step.

14. The network selection method according to claim 13, wherein
a network satisfying a condition required by the communication application is searched from the network characteristic database in the network selection step.

15. The network selection method according to claim 13, wherein
a network satisfying a condition most advantageous for a communication fee for the communication application is searched from the network characteristic database in the network selection process.

16. The network selection method according to claim 13, wherein
the application characteristic database and the network characteristic database are checked to select an appropriate network in the network selection step.

17. The network selection method according to claim 12, wherein
a connection destination address of the communication application is learned in the communication contents learning step.

18. The network selection method according to claim 12, wherein
a connection destination TCP (transmission control protocol) port number or a UDP (user datagram protocol) port number of the communication application is learned in the communication contents learning step.

19. The network selection method according to claim 12, wherein
an amount of communication or a frequency of the communication application is learned in the communication contents learning step.

20. The network selection method according to claim 12, wherein
a position when the communication application is being used is learned in the communication contents learning step.

21. The network selection method according to claim 12, wherein
a user interface for correction of learning contents of the communication contents learning step is provided for the communication device.

22. The network selection method according to claim 12, wherein
an appropriate network is selected on the basis of a detection result from a network retrieval server device for retrieving an optimum network depending on an identifier or communication contents of the communication application in the network selection step.

23. A recording medium storing a program of a network selection for use with a communication device connected to a plurality of networks by various communications, used to direct a computer to perform:
a network selection step of selecting an optimum network for communication contents of a communication application for performing communications; and
a communication contents learning step of learning communication contents of the communication application, and updating an application characteristic database storing a characteristic of the communication application on the basis of a learning result.
